(19) United States
(12) Patent Application Publication
(10) Pub. No.: US 2014/0136610 A1
(43) Pub. Date: May 15, 2014

(54) METHOD FOR CREATING GROUPS

(71) Applicant: XIAOMI INC., Beijing (CN)

(72) Inventors: Xingsheng LIN, Beijing (CN); Pengfei Zhang, Beijing (CN); Feng Hong, Beijing (CN); Jiangji Huang, Beijing (CN)

(73) Assignee: XIAOMI INC., Beijing (CN)

(21) Appl. No.: 14/157,680

(22) Filed: Jan. 17, 2014

Related U.S. Application Data
(63) Continuation-in-part of application No. PCT/CN2012/072655, filed on Mar. 20, 2012.

(30) Foreign Application Priority Data
Oct. 18, 2011 (CN) 201110316639.7

(51) Int. Cl. H04L 29/06

(52) U.S. Cl. CPC H04L 67/42
USPC 709/203

(57) ABSTRACT

The present disclosure discloses a method for creating groups, the method comprising a client setting up a condition for creating groups, and sending the condition to a server; the server searching the corresponding user information according to the conditions for creating groups, creating groups according to the corresponding user information, and sending information of created groups to the client and also sending the information of created group to all users in the groups. The method for creating groups permits a user to find relevant individuals quickly and create groups easily, without need of multiple inputs or outputs; moreover, the higher matching degree of group members could improve the enthusiasm of group chats and also stimulate the users to invite their friends to the interactive experience.

### CROSS REFERENCE TO RELATED APPLICATIONS

This application is a continuation-in-part of International Application No. PCT/CN2012/072655, filed Mar. 20, 2012, which claims priority to Chinese Patent Application No. 201110316639.7, filed Oct. 18, 2011, both of which are herein incorporated by reference in their entirety.

### TECHNICAL FIELD

The present disclosure relates to the field of Internet technology, and more particularly to a method for creating groups.

### BACKGROUND

Instant message software has become indispensable in the recreation and work of users, who require individual grouping functions due to different interactive circles.

Every individual has his or her own net friends and intends to group them for user-friendly management based on existing Internet products. Currently, a group must be created and named according to existing operating methods. Then, all net friends are added into this group one by one.

Yet, it's difficult to create intended groups quickly by such method, and the net friends must be firstly put into the list of friends, increasing the difficulty and complexity of creating groups with compromise of the user experience.

### SUMMARY

The purpose of the present invention is to provide a method for creating groups, which permit a user to find relevant individuals quickly and to create groups easily.

To this end, the present disclosure adopts the following technical scheme:

A method for creating groups, the method comprising:
setting up a condition for creating groups by a client, and sending the condition to a server;
searching corresponding user information by said server according to the condition for creating groups;
creating groups according to the corresponding user information by said server;
sending information of created groups to the client by said server, and sending the information of created groups to all users in the groups.

Preferably, the condition for creating groups refers to a photo; and the server searches the corresponding user information according to a human face in the photo.

Preferably, the condition for creating groups refers to user characteristic information of the client, including: birthday, Zodiac sign and/or constellation information.

Further disclosed is a computer system comprising a memory and a processor in communication with the memory, wherein the computer system is configured to perform the method for creating groups as described herein.

With the technical scheme of the present disclosure, a user can find relevant individuals quickly and create groups easily, without need for multiple inputs or outputs; moreover, the higher matching degree of group members could improve the enthusiasm of group chats and also stimulate the users to invite their friends into the interactive experience.

### BRIEF DESCRIPTION OF THE DRAWING

FIG. 1 is a flow process chart for creating groups in the preferred embodiment of the present disclosure.

FIG. 2 is a diagrammatic representation of a machine having a set of instructions for causing the machine to perform any of the one or more methods described herein.

### DETAILED DESCRIPTION

The preferred embodiment of the present disclosure is further described with reference to the accompanying drawings.

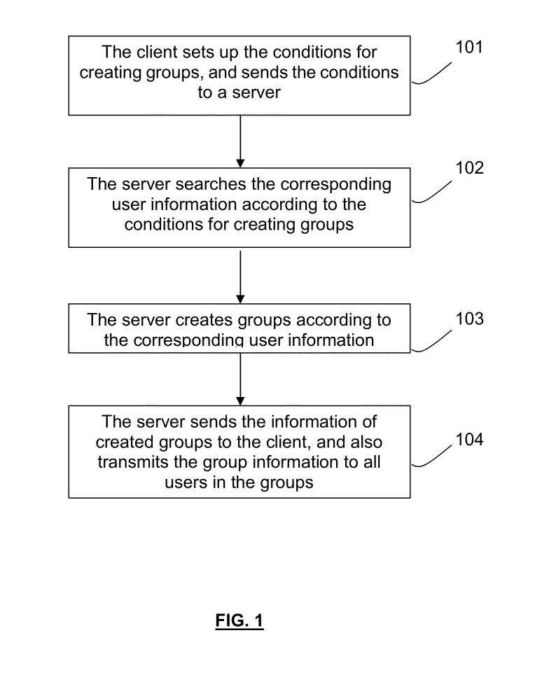

FIG. 1 is a flow diagram illustrating the method for creating groups in accordance with some embodiments of the present invention. Referring to FIG. 1, the process of creating groups contains the following steps:

In step 101, the client sets up a condition for creating groups, and sends the condition to a server. There are a variety of conditions for creating groups, for instance, the condition for creating groups refers to a photo, allowing the creation of a group for all individuals in the photo; the condition for creating groups also refers to the user characteristic information of the client, including: birthday, Zodiac sign and/or constellation information, allowing the creation of a group for those with the same Zodiac sign or constellation information.

In step 102, the server searches the corresponding user information according to the condition for creating groups. For instance, if the condition for creating groups refers to a photo, the server searches the corresponding user information according to the human face in the photo.

In step 103, the server creates groups according to the corresponding user information.

In step 104, the server feeds back information regarding the created groups to the client, and broadcasts the group information to all users in the groups.

Given special conditions for creating groups, the users in the group have a closer relationship, thereby enhancing their enthusiasm of group chats.

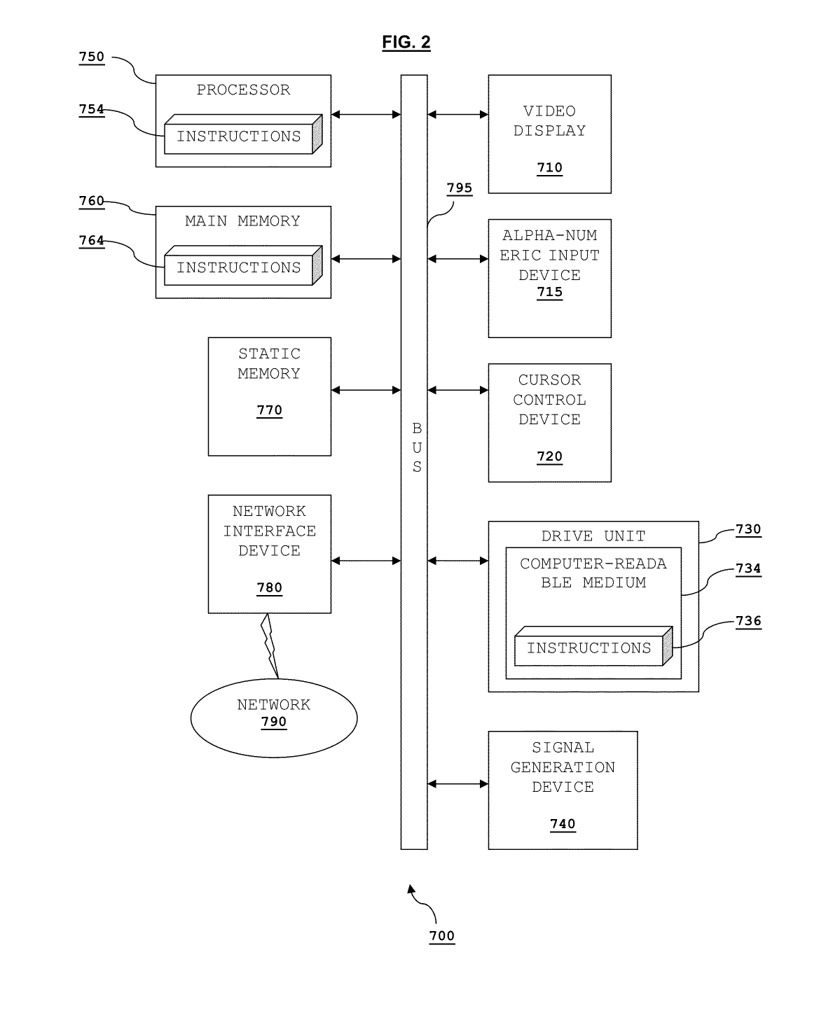

FIG. 2 shows a diagrammatic representation of machine in the exemplary form of computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, as a host machine, or as a peer machine in a peer-to-peer (or distributed) network environment. The machine may be a personal computer (PC), a tablet, a set-top box (STB), a Personal Digital Assistant (PDA), a cellular telephone, a web appliance, a network router, switch or bridge, a game console, a television, a CD player, a DVD player, a BD player, an e-reader, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

According to some embodiments, computer system 700 comprises processor 750 (e.g., a central processing unit (CPU), a graphics processing unit (GPU) or both), main memory 760 (e.g., read only memory (ROM), flash memory, dynamic random access memory (DRAM) such as synchronous DRAM (SDRAM) or Rambus DRAM (RDRAM), etc.) and/or static memory 770 (e.g., flash memory, static random access memory (SRAM), etc.), which communicate with each other via bus 795.

According to some embodiments, computer system 700 may further comprise video display unit 710 (e.g., a liquid crystal display (LCD), a light-emitting diode display (LED), an electroluminescent display (ELD), plasma display panels (PDP), an organic light-emitting diode display (OLED), a surface-conduction electron-emitted display (SED), a nanocrystal display, a 3D display, or a cathode ray tube (CRT)). According to some embodiments, computer system 700 also may comprise alphanumeric input device 715 (e.g., a keyboard), cursor control device 720 (e.g., a mouse or controller), disk drive unit 730, signal generation device 740 (e.g., a speaker), and/or network interface device 780.

Disk drive unit 730 includes computer-readable medium 734 on which is stored one or more sets of instructions (e.g., software 736) embodying any one or more of the methodologies or functions described herein. Software 736 may also reside, completely or at least partially, within main memory 760 and/or within processor 750 during execution thereof by computer system 700, main memory 760 and processor 750. Processor 750 and main memory 760 can also constitute computer-readable media having instructions 754 and 764, respectively. Software 736 may further be transmitted or received over network 790 via network interface device 780.

While computer-readable medium 734 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the disclosed embodiments. The term “computer-readable medium” shall accordingly be taken to include, but not be limited to, solid-state memories, and optical and magnetic media.

It should be understood that processes and techniques described herein are not inherently related to any particular apparatus and may be implemented by any suitable combination of components. Further, various types of general purpose devices may be used in accordance with the teachings described herein. It may also prove advantageous to construct a specialized apparatus to perform the methods described herein. Those skilled in the art will appreciate that many different combinations of hardware, software, and firmware will be suitable for practicing the disclosed embodiments.

The above is a detailed description of the technical features of the present disclosure based on a typical preferred embodiment. However, it should be appreciated that the present disclosure is capable of a variety of embodiments and various modifications by those skilled in the art, and all such variations or changes shall be embraced within the scope of the following claims.

1. A method for creating groups, the method comprising:
setting up a condition for creating groups by a client, and sending said condition to a server;
searching corresponding user information by said server according to said condition for creating groups;
creating groups according to the corresponding user information by said server; and
sending information of created groups to said client by said server, and sending said information of created groups to all users in said groups.

2. The method of claim 1,
wherein said condition for creating groups refers to a photo; and
wherein said server searches the corresponding user information according to a human face in said photo.

3. The method of claim 1,
wherein said condition for creating groups refers to the user's characteristic information of said client, including at least one of a birthday, Zodiac sign and constellation information.

4. A computer system comprising:
a memory; and
a processor in communication with the memory,
wherein the computer system is configured to perform a method comprising:
setting up a condition for creating groups by a client, and sending said condition to a server;
searching corresponding user information by said server according to said condition for creating groups;
creating groups according to the corresponding user information by said server; and
sending information of created groups to said client by said server, and sending said information of created groups to all users in said groups.
